(19) United States
(12) Patent Application Publication
(10) Pub. No.: US 2026/0134338 A1
(43) Pub. Date: May 14, 2026

(54) METHOD OF DISTRIBUTED USAGE OF AI BASED MODLES FOR DRIVING

(71) Applicant: AUTOBRAINS TECHNOLOGIES LTD, Tel Aviv-Yafo (IL)

(72) Inventor: Igal RAICHELGAUZ, Tel Aviv (IL)

(73) Assignee: AUTOBRAINS TECHNOLOGIES LTD, Tel Aviv-Yafo (IL)

(21) Appl. No.: 18/946,992

(22) Filed: Nov. 14, 2024

Related U.S. Application Data
(63) Continuation of application No. 18/946,987, filed on Nov. 14, 2024.

(51) Int. Cl. G06N 20/00

(52) U.S. Cl. CPC G06N 20/00

(57) ABSTRACT

A method of distributed usage of AI based models for driving. The method comprising submitting a request for use of a distributed storage with respect to a requested distributed storing, with an autonomous driving application. The requested distributed storing is at least one of: artificial intelligence models developed across driving scenarios, and data related to driving. And selectively obtaining remote access, based on the submitted request. The remote access involves uploading, downloading, and accessing the requested distributed storing, and facilitated under control of a user in charge of at least one of: the distributed storage, and the requested distributed storing.

### BACKGROUND

Vehicles include machine learning processes that are trained to cope with a vast number of scenarios. Nevertheless, over time vehicles face new scenarios.

When a vehicle faces a new scenario, the information regarding the new scenario may be wasted by not sharing the information regarding the new scenario. Alternatively—the vehicle that faces the new scenario belongs to a fleet of vehicles that share the information regarding the new scenario only with a manufacturer of the vehicle—for various reasons including data safety reasons.

There is a growing need to distribute in a secure manner the knowledge regarding these new scenarios to more entities.

### SUMMARY

There is provided a method, a non-transitory computer readable medium and a system as illustrated in the application.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a computerized system;

FIG. 2 illustrates an example of a vehicle;

FIG. 3 illustrates an example of a computerized environment and of multiple vehicles;

FIG. 4 illustrates an examples of a computerized environment;

FIG. 5 illustrates an examples of a computerized environment;

FIG. 6 illustrates an examples of a computerized environment;

FIG. 7 illustrates examples of a method;

FIG. 8 illustrates an example of a method; and

FIG. 9 illustrates an example of a method.

### DETAILED DESCRIPTION

The different figures illustrates examples of units and/or software and/or information items and/or steps and/or components. These examples are provided for brevity of explanation. At least one of the units and/or software and/or information items and/or steps and/or components is optional or mandatory.

Artificial intelligence is used in relation to machines that mimic human intelligence and human cognitive functions like learning and problem solving. There are three types of artificial intelligence that include artificial super intelligence, artificial narrow intelligence and artificial general intelligence. Machine learning is a subset of artificial intelligence that allows for optimization. Deep machine learning is a subset of machine learning that uses larger datasets for training and learns in a different manner than not deep machine learning. Neural networks are a subset of machine learning and are used for implementing deep learning.

Any reference in the application to any of the terms “artificial intelligence”, “machine learning”, “deep learning” or “neural network” should be applied mutatis mutandis to any other term of “artificial intelligence”, “machine learning”, “deep learning” or “neural network”. For example—any reference to a neural network should be applied mutatis mutandis to artificial intelligence and/or should be applied mutatis mutandis to “machine learning”, and/or should be applied mutatis mutandis to “deep learning”.

The term obtaining include receiving and/or generating.

According to an embodiment a scenario includes at least one of (a) a location of the vehicle, (b) one or more weather conditions, (c) one or more contextual parameters, (d) a road condition, (e) a traffic parameter. Various examples of a road condition may include the roughness of the road, the maintenance level of the road, presence of potholes or other related road obstacles, whether the road is slippery, covered with snow or other particles. Various examples of a traffic parameter and the one or more contextual parameters may include time (hour, day, period or year, certain hours at certain days, and the like), a traffic load, a distribution of vehicles on the road, the behavior of one or more vehicles (aggressive, calm, predictable, unpredictable, and the like), the presence of pedestrians near the road, the presence of pedestrians near the vehicle, the presence of pedestrians away from the vehicle, the behavior of the pedestrians (aggressive, calm, predictable, unpredictable, and the like), risk associated with driving within a vicinity of the vehicle, complexity associated with driving within of the vehicle, the presence (near the vehicle) of at least one out of a kindergarten, a school, a gathering of people, and the like. A contextual parameter may be related to the context of the sensed information—context may be depending on or relating to the circumstances that form the setting for an event, statement, or idea.

According to an embodiment, a narrow scenario includes at least X elements (X exceeds 2, 3, 4, 5, 6, and the like) related to at least one or more of (a) the location of the vehicle, (b) the one or more weather conditions, (c) the one or more contextual parameters, (d) the road condition, or (e) the traffic parameter.

For example—a narrow scenario includes at least X contextual parameters.

According to an embodiment, a narrow AI model is associated with a narrow scenario. For example-driving in a parking lot during the evening at the presence of pedestrians. For example driving near a crowd of multiple pedestrians with different behaviors. For example—having a combination of time, weather conditions (e.g. night/day/cloudy/rainy/foggy/etc) and a specified road related parameter (e.g. uphill, downhill, highway, traffic jam, etc), and the like.

According to an embodiment, there is provided a solution that allows the distribution of data regarding new scenarios and/or artificial intelligence (AI) models trained to cope with the new scenarios between multiple users in a safe manner.

According to an embodiment, AI models of a certain point in time may be changes, have one or more artificial intelligence model added and/or or many have one or more artificial intelligence model removed, in order to adapt to newly received driving related data.

According to an embodiment there is provided a method of providing artificial intelligence models development access for autonomous based driving, the method includes:
Storing, in a distributed manner or in a centralized manner, artificial intelligence models each developed across a narrow driving scenario, and/or data originating from sensory data captured in an environment of a vehicle and stored in correspondence with the artificial intelligence models.
Providing, to a first group of multiple users, a first remote access, a view of the at least one of: the artificial intelligence models or the data.
Selectively providing, contingent on a request for use of a distributed storing, to a second group of multiple users a second remote access, the use of the at least one of: the artificial intelligence models or the data, such that the selectively providing is by facilitating the use of the requested distributed storing to a requesting user, under control of a user in charge of the requested distributed storing. The use of a requested artificial intelligence model is for use with an autonomous level driving application. The use of requested data is for use in a development of an artificial intelligence model.

According to an embodiment, the method is related to driving other that fully autonomous driving—for example to a driver assistance, to a driving operation that required human intervention, and the like.

According to an embodiment an artificial intelligence model is a machine learning model (not necessarily implementing a neural network) implementing a decision-based algorithm for a narrow driving scenario or a neural network trained across a narrow driving scenario.

According to an embodiment, a narrow artificial model is responsible to up to 0.01%, up to 0.1 %, or up to 1% and the like of all scenarios.

According to an embodiment, the access provided by the method includes at least one of storing the AI models—e.g. neural network/executable machine learning processes/decision-based algorithm/trained data/software/hardware/firmware executables themselves, running code, etc. Or alternatively, data only-such as recordings, and so.

According to an embodiment, any one of the steps of the method may be executed offline or in real time or in test mode or in a shadow mode.

According to an embodiment, any group of users of the first group or the second group may be unrestricted or restricted. A restricted group may be provided by higher priority, more generous access rights, and the like.

According to an embodiment the access provided by the method may include at least one of:
A user of second group (for example a developer) submits a request to download a specific AI model from an existing library in offline.
The developer downloads the specific AI model and tests it (for example in real-time), first running the specific AI model in shadow mode and later in supervised/unsupervised mode based on the maturity of the specific AI model.
The developer also download the specific AI model to a skills factory (an example of a skills factory is illustrated in U.S. patent applications Ser. No. 18/908,831 which is incorporated herein by reference) and train it with more data (offline), test it and then upload to it to the existing library.
A user of second group (for example a developer) submits a request to download specific data related to a specific AI model.
The developer downloads the specific data related to a specific AI model and develops an AI model.

According to an embodiment, there is provided a system of generating artificial intelligence models for driving related scenarios, the system comprising at least one processing device configured to:
store, in a distributed manner, at least one of: artificial intelligence models each developed across a narrow driving scenario, and data originating from sensory data captured in an environment of a vehicle and stored in correspondence with the artificial intelligence models;
provide, to a first group of multiple users, a first remote access, a view of the at least one of: the artificial intelligence models or the data; and
selectively provide, contingent on a request for use of a distributed storing, to a second group of multiple users a second remote access, the use of the at least one of: the artificial intelligence models or the data, such that the selectively providing is by facilitating the use of the requested distributed storing to a requesting user, under control of a user in charge of the requested distributed storing, wherein the use of a requested artificial intelligence model is for use with an autonomous level driving application, and wherein the use of requested data is for use in a development of an artificial intelligence model

According to an embodiment, there is provided a non-transitory computer readable medium storing instructions that, when executable by at least one processing device, cause the device to:
store, in a distributed manner, at least one of: artificial intelligence models each developed across a narrow driving scenario, and data originating from sensory data captured in an environment of a vehicle and stored in correspondence with the artificial intelligence models;
provide, to a first group of multiple users, a first remote access, a view of the at least one of: the artificial intelligence models or the data; and
selectively provide, contingent on a request for use of a distributed storing, to a second group of multiple users a second remote access, the use of the at least one of: the artificial intelligence models or the data, such that the selectively providing is by facilitating the use of the requested distributed storing to a requesting user, under control of a user in charge of the requested distributed storing, wherein the use of a requested artificial intelligence model is for use with an autonomous level driving application, and wherein the use of requested data is for use in a development of an artificial intelligence model.

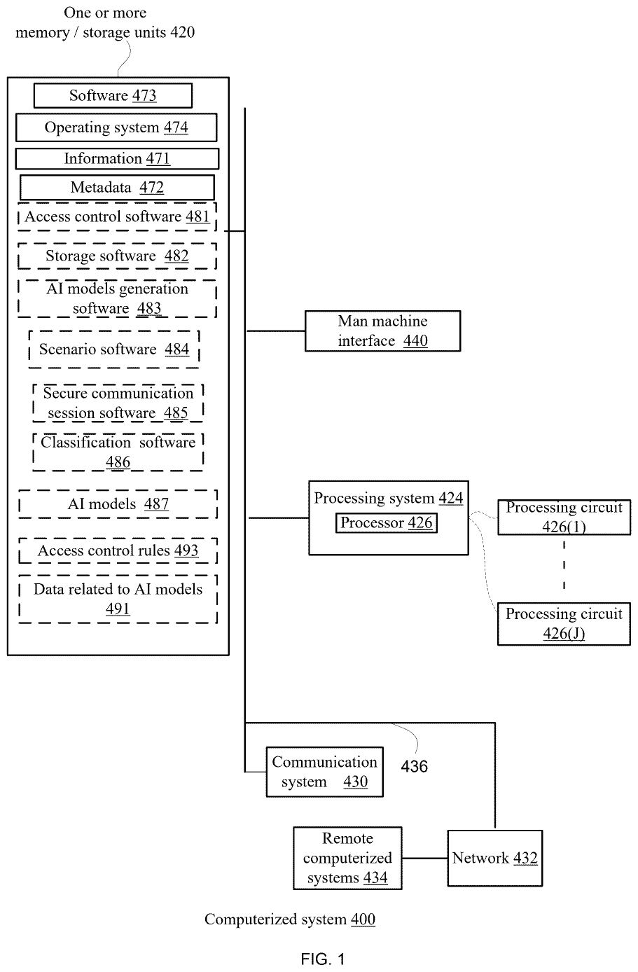

FIG. 1 illustrates an example of a computerized system 400.

Computerized system 400 includes a man machine interface 440 having or being in communication with man machine interface (MMI) controller (not shown), a communication system 430, one or more memory and/or storage units 420, a processing system 424 including processor 426. The computerized system may be a server, a laptop, a desktop or any other computer and may include or be in communication with a sensing unit and/or a controller.

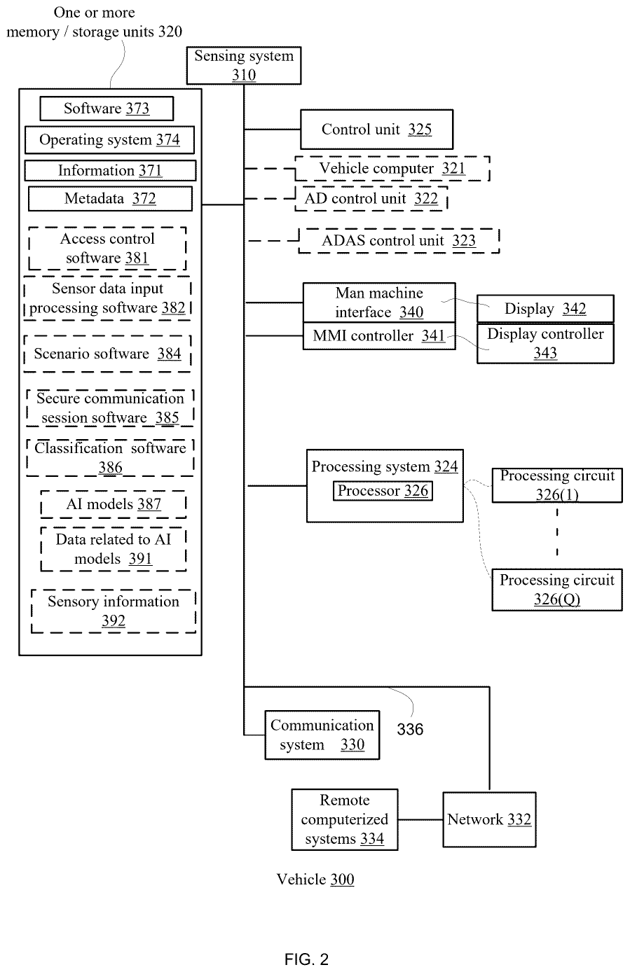

According to an embodiment, computerized system 400 is in communication with network 432 and one or more other remote computerized systems 434 that are in communication with network 432. An example of a remote computerized system is a vehicle (such as vehicle 300 of FIG. 2), a server or one or more computers having access to a storage system.

According to an embodiment, the communication system 430 is configured to enable communication between the one or more memory and/or storage units 420 and/or any one of the additional units and/or the network 432 (that is in communication with the remote computerized systems). Communication system 430 is also configured to enable communication with other elements such as man machine interface 440.

The memory and/or storage units 420 was shown as storing software. Any reference to software should be applied mutatis mutandis to code and/or firmware and/or instructions and/or commands, and the like.

Processor 426 includes a plurality of processing units 426(1)-426(J), J is an integer that exceeds one. Any reference to one unit or item should be applied mutatis mutandis to multiple units or items. For example—any reference to processor should be applied mutatis mutandis to multiple processors, any reference to communication system 430 should be applied mutatis mutandis to multiple communication systems.

According to an embodiment, the one or more memory and/or storage units 420 includes one or more memory unit, each memory unit may include one or more memory banks.

According to an embodiment, the one or more memory and/or storage units 420 includes a volatile memory and/or a non-volatile memory. The one or more memory and/or storage units 420 may be a random-access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any content may be stored in any part or any type of the memory and/or storage units.

According to an embodiment, the at least one memory unit stores at least one database—such as any database known in the art—such as DB2®, Microsoft® Access, Microsoft® SQL Server, Oracle®, mySQL, PostgreSQL, and the like.

The memory and/or storage units 420 are configured to store firmware and/or software, one or more operating systems, data and metadata required to the execution of any of the methods mentioned in this application.

The memory and/or storage units 420 was shown as storing software. Any reference to software should be applied mutatis mutandis to code and/or firmware and/or instructions and/or commands, and the like.

Various units and/or components are in communication with each other using any communication elements and/or protocols. An example of a communication system is denoted 430. Other communication elements may be provided.

The communication system 430 may be in communication with bus 436. The bus represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

Network 432 that is located outside the computerized system and is used for communication between the computerized system and at least one remote computing system and/or one or more vehicles. By way of example, a remote computing system can be a personal computer, a laptop computer, portable computer, a server, a router, a network computer, a peer device or other common network node, and so on. Logical connections between the processor and either one of remote computing systems can be made via a local area network (LAN) and a general wide area network (WAN). Such network connections can be through a network adapter (may belong to communication system 430) which can be implemented in both wired and wireless environments. Such networking environments are conventional and commonplace in offices, enterprise-wide computer networks, intranets, and a larger network such as the internet.

It should be noted that at least a part of the content illustrated as being stored in one or more memory/storage units 420 may be stored outside the computerized system. It should also be noted that the processor may evaluate signatures generated by a plurality of detectors.

Examples of generating signatures and/or cropping images are provided in U.S. patent application Ser. No. 18/527,701 which is incorporated herein by reference.

According to an embodiment, the memory and/or storage units 420 stores at least one of: operating system 474, information 471, metadata 472, and software 473.

Examples of software include at least one of:
Access control software 481 that once executed by the processing system causes the processing system to control the access to at least one of AI models 486 or the data related to the AI models 491 and/or to allow a user (also referred to as a contributing user) that provided one or more of the AI models and/or the data related to the AI models to control access of another user that access to the one or more of the AI models and/or the data related to the AI models.
Storage software 482 that once executed by the processing system causes the processing system to manage the storage, at least in part under the control of the access control software, of the AI models and/or the data related to the AI models.
AI models generation software 483 that once executed by the processing system causes the processing system to generate AI models. According to an embodiment an AI model is either of a known predefined architecture or is associated with architecture metadata that describes the architecture of the AI model—so that third parties, once granted access to the AI model may implement the AI model.
Scenario software 484 that once executed by the processing system causes the processing system to identify scenarios by vehicle based on sensory data. According to an embodiment, the scenario software is provided in a binary code and is not understandable by human. Alternatively, the scenario software is a source code that is understood by a person.
Classification software 486 that once executed by the processing system causes the processing system to classify one or more objects in the sensory data and/or classify the scenario. According to an embodiment, the classification software is provided in a binary code and is not understandable by human. Alternatively, the classification software is a source code that is understood by a person. According to an embodiment there is an overlap (partially or full) between the classification software and the scenario software.
Secure communication session software 485 that once executed by the processing system causes the processing system to initiate and/or participate in one or more secure communication sessions.
AI models 487 for use for driving—such as autonomous driving, driver assistance, and the like. One or more AI models, once executed by the processing system causes the processing system to one or more AI models outputs that may be one or more driving related outputs or may be further processed to provide the driving related outputs.

Only one or some of these software may be stored in the one or more memory/storage units 420.

Examples of information and/or metadata include at least one of access control rules 493 that are used by the processing system when executing the access control software 481, and data related to AI models 491.

A data related to an AI model is data that was used for training the AI model. The data related to the AI model may be the raw sensory data that was used for training the AI model, sensory data that was processed, and the like.

Only one or some of these information and/or metadata may be stored in the one or more memory/storage units 420.

According to an embodiment, an AI model is associated with a scenario and is trained to provide outputs that are adjusted to or generated to cope with the scenario. According to an embodiment, a scenario is associated with one or more AI models.

According to an embodiment, the scenario associated with a scenario signature and a vehicle during inference compares a signature generated based on sensory data to scenario associated signatures.

According to an embodiment, scenario signatures are generated by:
Obtaining sensory data regarding driving (also referred to as driving related data).
Generating driving related data signatures. The signatures may be embeddings, signatures of embeddings, sparse binary signatures, sparse signatures, or differ from embeddings. Examples of generating signatures and/or cropping images are provided in U.S. patent application Ser. No. 18/527,701 which is incorporated herein by reference.
Clustering the driving related data signatures.
Clustering the driving related data based on the signatures of the driving related data. Accordingly—driving related data units that have signatures that belong to the same signature cluster are clustered together.
Associating the clusters with scenarios-so that the scenario signatures are signatures of the clusters.

During inference a vehicle generated a signature of sensory data and compares it to the scenario signatures to find a match.

By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

Any content may be stored in any part or any type of memory and/or storage units.

According to an embodiment, at least one memory unit stores at least one database—such as any database known in the art—such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted 430. Other communication elements may be provided.

According to an embodiment, processing system 424 is configured to perform method 600 while executing software.

According to an embodiment, processing system 424 is configured to perform at least one of the following when executing software:
Store, in a distributed manner or in a centralized manner, artificial intelligence models each developed across a narrow driving scenario, and/or data originating from sensory data captured in an environment of a vehicle and stored in correspondence with the artificial intelligence models.
Provide, to a first group of multiple users, a first remote access, a view of the at least one of: the artificial intelligence models or the data.
Selectively provide, contingent on a request for use of a distributed storing, to a second group of multiple users a second remote access, the use of the at least one of: the artificial intelligence models or the data, such that the selectively providing is by facilitating the use of the requested distributed storing to a requesting user, under control of a user in charge of the requested distributed storing. The use of a requested artificial intelligence model is for use with an autonomous level driving application. The use of requested data is for use in a development of an artificial intelligence model.

According to an embodiment, processing system 424 is configured to perform at least one of the following when executing software:
Submitting a request for use of a distributed storage with respect to a requested distributed storing, with an autonomous driving application, from at least one of: artificial intelligence models developed across driving scenarios, and data related to driving.
Selectively obtaining a first remote access, based on the submitted request, wherein the selectively obtaining involves at least one of: uploading, downloading, and accessing the requested distributed storing, such that the selectively obtained is facilitated under control of a user in charge of at least one of: the distributed storage, and the requested

According to an embodiment, processing system 424 is configured to perform at least one of the following when executing software:
Store, in a distributed storage, models metadata related to models that represent a group of artificial intelligence skills, the models trained across specified road scenarios and are applicable for autonomous driving.
Receive, from a contributing user, a contribution request to add a new model metadata related to a new mode or to update an existing model metadata related to an existing model.
Facilitate a controlled access to the distributed storage by the contributing user for conditionally adding the new model metadata or updating the existing model metadata, while preventing any other user of the first group of users that lacks an authorization to add the new model metadata from using the new model. Wherein the facilitating is executed automatically and in real time, and includes transmitting a request to access notification to the contributing user.

FIG. 2 illustrates an example of vehicle 300.

Vehicle 300 includes a man machine interface 340 having or being in communication with man machine interface (MMI) controller 341, wherein in FIG. 1 the MMI is a display 342 or includes a display 342 and the MMI controller is a display controller 343 or includes the display controller 343, a communication system 330, one or more memory and/or storage units 320, a processing system 324 including processor 326. The communication system 330, the one or more memory and/or storage units 320, and the processing system 324 may belong to a computerized system of vehicle 300. The computerized system may be a server, a laptop, a desktop or any other computer and may include or be in communication with a sensing unit and/or a controller.

According to an embodiment, vehicle 300 is in communication with network 332 and one or more other remote computerized systems 334 that are in communication with network 332. An example of a remote computerized system is a server or one or more computers having access to a storage system that stores items related to one or more portions of one or more groups of neural networks—at least some of which are not currently stored in the vehicle.

According to an embodiment, the communication system 330 is configured to enable communication between the one or more memory and/or storage units 320 and/or any one of the additional units and/or the network 332 (that is in communication with the remote computerized systems). Communication system 330 is also configured to enable communication with other elements such as sensing system 310, man machine interface 340, control unit 325, vehicle computer 321, autonomous driving control unit 322 (denoted AD control unit), advanced driver assistance system (ADAS) control unit 323 (denoted ADAS control unit), and the like.

The memory and/or storage units 320 was shown as storing software. Any reference to software should be applied mutatis mutandis to code and/or firmware and/or instructions and/or commands, and the like.

Processor 326 includes a plurality of processing units 326(1)-326(Q), Q is an integer that exceeds one. Any reference to one unit or item should be applied mutatis mutandis to multiple units or items. For example—any reference to processor should be applied mutatis mutandis to multiple processors, any reference to communication system 330 should be applied mutatis mutandis to multiple communication systems.

According to an embodiment, the one or more memory and/or storage units 320 includes one or more memory unit, each memory unit may include one or more memory banks.

Any reference to memory and/or storage units 420 should be applied mutatis mutandis to one or more memory and/or storage units 320.

Any reference to communication system 430 should be applied mutatis mutandis to communication system 330.

Any reference to bus 436 should be applied mutatis mutandis to bus 336.

Any reference to network 432 should be applied mutatis mutandis to network 332.

According to an embodiment, the memory and/or storage units 320 stores at least one of: operating system 374, information 371, metadata 372, and software 373.

Examples of software include at least one of:
Access control software 481 that once executed by the processing system causes the processing system to participate in accessing one or more AI models and/or data related to the AI modules. According to an embodiment the vehicle is associated with a user that includes a computerized system and that user, and not the vehicle, is involved in the access of the AI models and/or data related to the AI modules.
Sensor data input processing software 382 that once executed by the processing system causes the processing system 324 to process sensory data related to the vehicle during inference.
Scenario software 384 that once executed by the processing system causes the processing system to identify scenarios by vehicle based on sensory data. According to an embodiment, the scenario software is provided in a binary code and is not understandable by human. Alternatively, the scenario software is a source code that is understood by a person.
Classification software 386 that once executed by the processing system causes the processing system to classify one or more objects in the sensory data and/or classify the scenario. According to an embodiment, the classification software is provided in a binary code and is not understandable by human. Alternatively, the classification software is a source code that is understood by a person. According to an embodiment there is an overlap (partially or full) between the classification software and the scenario software.
Secure communication session software 485 that once executed by the processing system causes the processing system to initiate and/or participate in one or more secure communication sessions.
AI models 387 for use for driving—such as autonomous driving, driver assistance, and the like. One or more AI models, once executed by the processing system causes the processing system to one or more AI models outputs that may be one or more driving related outputs or may be further processed to provide the driving related outputs.

Only one or some of these software may be stored in the one or more memory/storage units 420.

Examples of information and/or metadata include at least one of data related to AI models 491 and sensory information 392.

A data related to an AI model is data that was used for training the AI model. The data related to the AI model may be the raw sensory data that was used for training the AI model, sensory data that was processed, and the like.

Only one or some of these information and/or metadata may be stored in the one or more memory/storage units 420.

Only one or some of these software may be stored in the one or more memory/storage units 320.

The control unit 325 may cooperate with ADAS control unit 323 and/or with AD control unit 322 and/or may control or communicate with other vehicle components—including vehicle computer.

The ADAS control unit 323 is configured to control ADAS operations.

The AD control unit 322 is configured to control autonomous driving of the autonomous vehicle.

The vehicle computer 321 is configured to control the operation of the vehicle-especially controlling the engine, the transmission, and any other vehicle system or component.

The vehicle computer 321 may be in communication with an engine control module, a transmission control module, a powertrain control module, and the like.

The sensing system 310 may include optics, a sensing element group, a readout circuit, and an image signal processor. Optics are followed by a sensing element group such as line of sensing elements or an array of sensing elements that form the sensing element group. The sensing element group is followed by a readout circuit that reads detection signals generated by the sensing element group. An image signal processor is configured to perform an initial processing of the detection signals—for example by improving the quality of the detection information, performing noise reduction, and the like. The sensing system 310 is configured to output one or more sensed information units (SIUs).

Control unit 325 is configured to control the operation of the sensing system 310, and/or the one or more memory and/or storage units 320 and/or the one or more additional units (except the controller).

By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

Any content may be stored in any part or any type of memory and/or storage units.

According to an embodiment, at least one memory unit stores at least one database—such as any database known in the art—such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted 330. Other communication elements may be provided.

According to an embodiment, processing system 324 is configured to perform method 600, while executing software.

According to an embodiment, processing system 324 is configured to perform, while executing software:
Obtain, during inference, sensory data.
Calculate one or more signatures of the sensory data.
Compare the one or more signatures of the sensory data to scenario signatures.
Identify one or more relevant scenarios that have one or more scenario signatures that match the one or more signatures of the sensory data.
When there the comparison indicated that there is no matching scenario—determine that a potentially new scenario is identified and send the sensory data related to the potentially new scenario for processing—for example to a user associated with the vehicle.
Generate or participate in the generation of a driving related output. with respect to the vehicle.

According to an embodiment, the driving related output is used for autonomously driving the vehicle.

According to an embodiment, the driving related output is used by an advanced driver assistance system (ADAS) related to the vehicle.

According to an embodiment, the driving related output includes at least one of:
An instruction executable by a man machine interface controller, to provide a recommendation to a driver regarding a navigation of the vehicle.
A request aimed to the man machine interface controller, to provide a recommendation to a driver regarding a navigation of the vehicle.
An instruction executable by an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
A request aimed to an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
An instruction executable by a driver assistance control unit (such as but not limited to an ADAS control unit) of the vehicle to perform a driver assisting operation—such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
A request aimed to a driver assistance control unit (such as but not limited to an ADAS control unit) of the vehicle to perform a driver assisting operation—such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
An instruction executable by a computer vehicle related to a manner of operation of any component of the vehicle such as brakes, engine, and the like.
A request sent to a computer vehicle related to a manner of operation of any component of the vehicle such as brakes, engine, and the like.
Information about the environment of the vehicle.
A prediction of a future path of the vehicle.
A prediction of a behavior of one or more road element.
An emergency alert.
A Collision Alert.

According to an embodiment, the method includes outputting and/or transmitting an/or storing and/or instructing to respond to and/or triggering a response to and/or controlling a response to and/or performing a respond to any of the driving related output listed above and/or below.

According to an embodiment, the method includes generating and/or requesting and/or determining and/or instructing and/or triggering and/or controlling and/or transmitting and/or outputting and/or preforming at least one of a warning, an alert signal, a driving alert, an estimated future driving of the vehicle, an estimated future behavior (e.g. movement) of any road element, an autonomous driving operation, an driving assistance output, a prediction output with respect to the behavior (e.g. movement, etc) of the element in the environment—and/or in the environment with re to the vehicle, an operation and/or response in compliant with one or more levels of autonomous driving—such as L2, L2+, L2++, L3 or L4 autonomous driving.

The providing of the driving related output may include storing the driving related output at a location accessible to another unit controller, transmitting instructions of the driving related output to the other unit, sending an indication about the generation of the instructions of the driving related output to the other unit man machine interface controller.

According to an embodiment, the method may include outputting and/or transmitting an/or storing and/or instructing to respond to and/or triggering a response to and/or controlling a response to and/or performing a respond to any of the driving related output listed above and/or below.

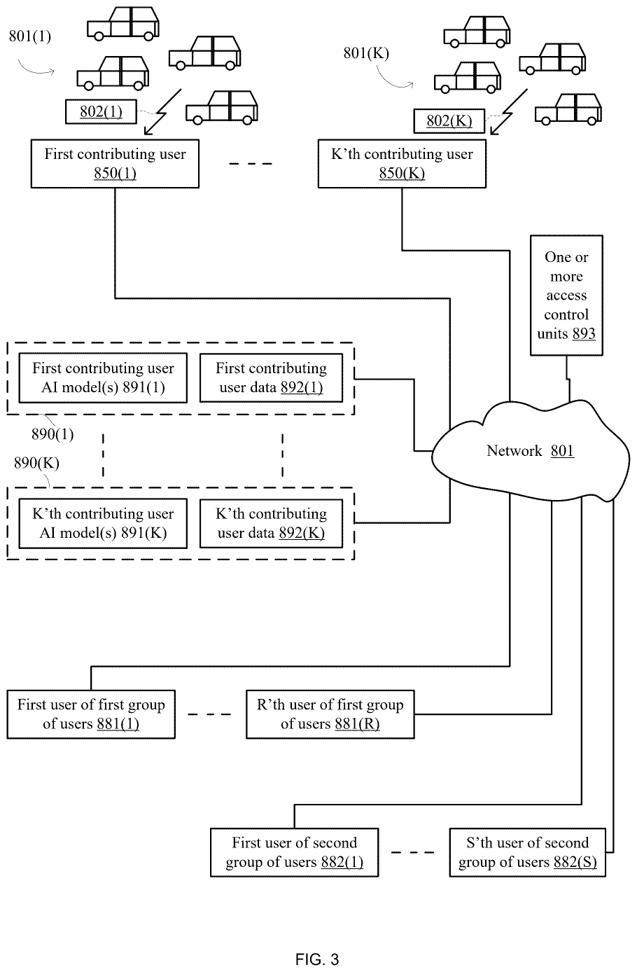

FIG. 3 illustrates an example of a computerized environment and of multiple vehicles.

The computerized environment includes a first plurality (K) of contributing users (850(1)-850(K)), each contributing user is a computerized system (under the control or one or more entity such as a vehicle manufacturer, a vehicle software vendor, a vehicle hardware vendor, an original equipment manufacturer (OEM), a distributer, a fleet manager, the police, and the like) capable of generating one or more AI models associated with one or more situations and/or data related to one or more AI models (see for example data related to AI models 391 of FIG. 2).

The data related to one or more AI models is sensory data provided from one vehicle associated with the contributing user. Alternatively—the contributing user (and/or the vehicles) processes sensory data provided from one vehicle associated with the contributing user to provide data related to one or more AI models.

In FIG. 3, first vehicles collectively denoted 801(1) provide first sensory data (or first processed sensory data) 802(1) to first contributing user 850(1). K'th vehicles collectively denoted 801(K) provide K'th sensory data (or K'th processed sensory data) 802(K) to K'th contributing user 850(K).

In FIG. 3, the first till K'th contributing users are in communication (via one or more networks such as network 801) with one or more access control units 893 that apply access control to a distributed storage in which each contributing user is allocated a dedicated storage system.

For example—first contributing user AI model(s) 891(1) and first contributing user data 892(1) (which is the data related to the first contributing user AI model(s)) is stored at first contributing user storage system 890(1).

For example—K'th contributing user AI model(s) 891(K) and K'th contributing user data 892(K) (which is the data related to the K'th contributing user AI model(s)) is stored at K'th contributing user storage system 890(K).

According to an embodiment—the distributed storing may allocate more than one storage system to a contributing user and/or allocate another storage system to two or more contributing users.

FIG. 3 also illustrates a first group of users and a second group of users that are selectively granted different rights.

The first group of users includes a second plurality (R) of users (first user of first group of users 881(1)—R'th user of first group of users 881(R)).

The second group of users includes a third plurality(S) of users (first user of second group of users 882(1)—S'th user of second group of users 882(S)).

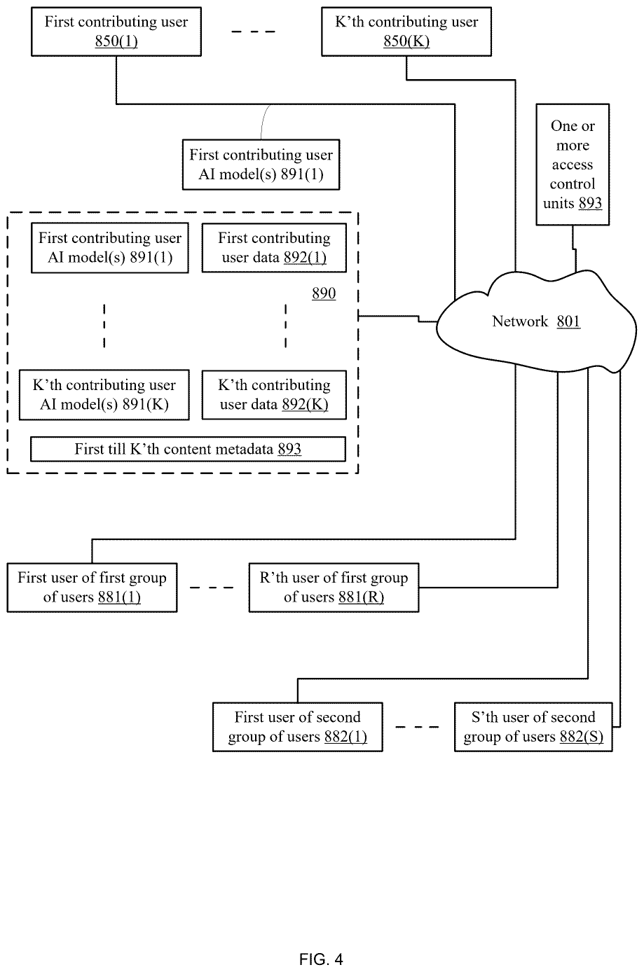

FIG. 4 illustrates an example of a computerized environment that has a centralized storage—whereas a single storage system 890 is used for storing the content provided by the contributing users.

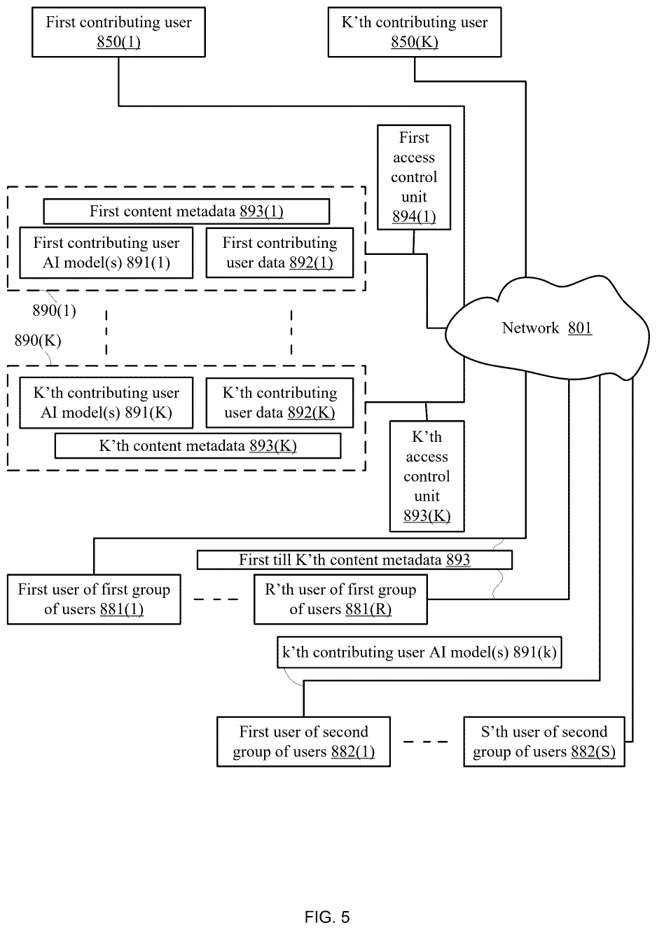

FIG. 4 also illustrates the single storage system 890 as storing the first till K'th content metadata 893 that provides information regarding the content provided to the first users by the contributing users. This metadata is stored in a segmented or distributed manner in any of the one or more storage systems of FIGS. 2, 4-6. An example of the segmented storage of this metadata is illustrated in FIG. 5.

FIG. 4 also illustrates the first contributing user as providing the first contributing user AI model(s) 891(1).

FIG. 5 illustrates an example of a computerized environment that has the same distributed storage as illustrated in FIG. 3.

FIG. 5 also illustrates the distributed storage of content metadata. The storage system allocated to the k'th contributing user stores the content metadata related to this contributing user. For example—in FIG. 5, the first storage system stores the first content metadata 893(1) and the K'th storage system stores the K'th content metadata 893(K).

FIG. 5 also illustrates the provision of the first till K'th content metadata 893 to the first users, and the provision of the kt'h contributing user AI model(s) 891(k) to a user of the second group of users.

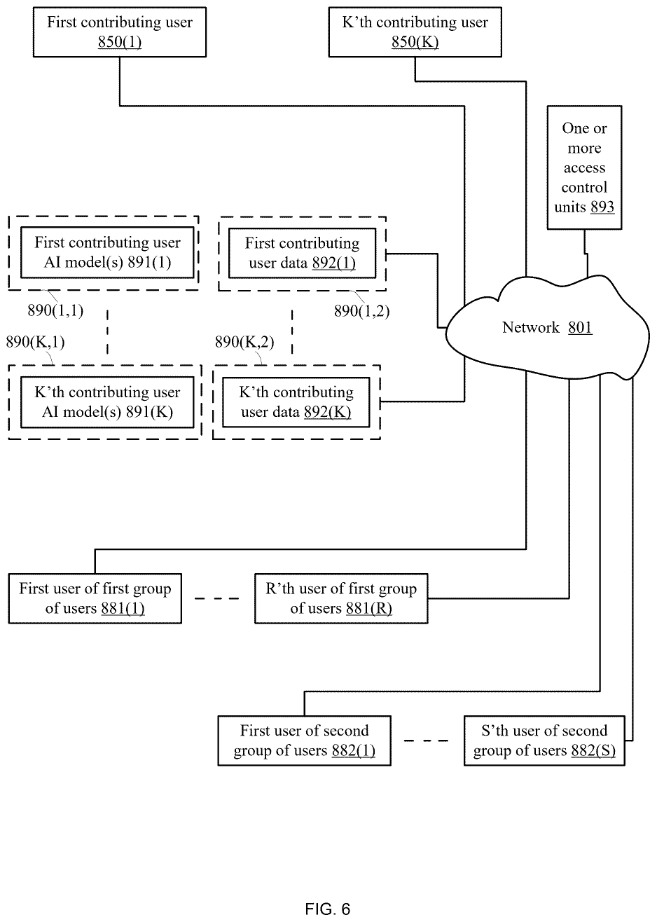

FIG. 6 illustrates an example of a computerized environment and of multiple vehicles in which different storage systems are allocated to AI model(s) of different contributing suers and other storage systems are allocated to the data related to the AI model(s) of different contributing users.

For example:
Storage system 890(1,1) is allocated for storing first contributing user AI model(s) 891(1).
Storage system 890(1,2) is allocated for storing first contributing user data 892(1) (which is the data related to the first contributing user AI model(s)).
Storage system 890(K,1) is allocated for storing K'th contributing user AI model(s) 891(K).
Storage system 890(K,2) is allocated for storing K'th contributing user data 892(K) (which is the data related to the K'th contributing user AI model(s)).

FIG. 3-6 illustrated storing of pairs of AI model(s) and associated data. It should be noted that in relation to a specified AI model-the computerized environment may store only the specified AI model or only the data related to the specified AI model. The uploading is determined by the contributing users.

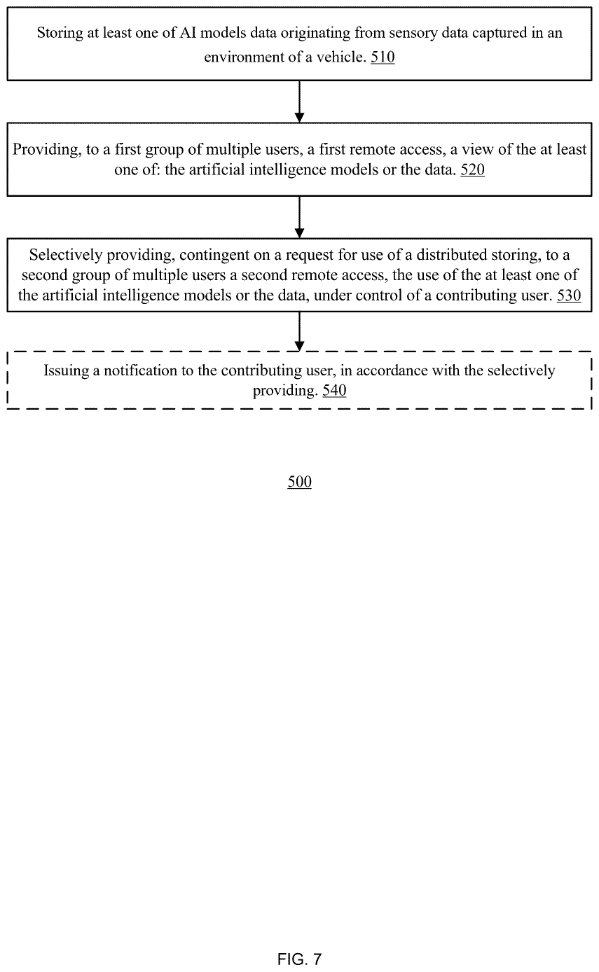

FIG. 7 is an example of method 500 of providing artificial intelligence models development access for autonomous based driving.

According to an embodiment, method 500 includes step 510 of storing, in a distributed manner or in a centralized manner, artificial intelligence models each developed across a narrow driving scenario, and/or data originating from sensory data captured in an environment of a vehicle and stored in correspondence with the artificial intelligence models.

According to an embodiment, the sensory data may be sensed by one or more sensors related to one or more vehicles. A sensor related to a vehicle may belong to the vehicle, may be attached to the vehicle, may be spaced apart from the vehicle, may follow a movement of the vehicle, may not follow the movement of the vehicle, may be an aerial sensor, a satellite sensor, an airborne sensor, a ground sensor, and the like.

According to an embodiment, any sensor of the one or more sensors related to the one or more vehicles may be at least one of an image sensor, a non-image sensor, a visible light sensor, a sensor operating in one or more frequencies other than visible light, a radar, a sonar, a magnetometer, a LIDAR, an ultrasonic sensor, an infrared sensor, a near infrared sensor, a radiometer, a thermal sensor, a microwave sensor, a x-ray sensor, a gravitometer, an altimeter, a barometer, a synthetic-aperture radar, a monochromatic sensor, a passive sensor, an active sensor, a sensor for sensing an environment of the vehicle.

According to an embodiment, any sensor of the one or more sensors related to the one or more vehicles may be a vehicle sensor sensing a status of one or more vehicle component (engine, brakes, chassis, wheels, gear, driving wheel, clutch, shock absorber), a vehicle velocity sensor, a vehicle acceleration sensor, and the like.

According to an embodiment, step 510 is followed by step 520 of providing, to a first group of multiple users, a first remote access, a view of the at least one of: the artificial intelligence models or the data.

According to an embodiment, step 520 is followed by step 530 of selectively providing, contingent on a request for use of a distributed storing, to a second group of multiple users a second remote access, the use of the at least one of: the artificial intelligence models or the data. The selectively providing is by facilitating the use of the requested distributed storing to a requesting user, under control of a user in charge of the requested distributed storing. The use of a requested artificial intelligence model is for use with an autonomous level driving application. The use of requested data is for use in a development of an artificial intelligence model.

According to an embodiment, step 530 is followed by step 540 of issuing a notification to the contributing user, in accordance with the selectively providing.

According to an embodiment, the data is sensory data captured by sensors of a vehicle in an environment of the vehicle, clustered per driving scenario in accordance with the artificial intelligence models.

According to an embodiment, the data is indexed data, and includes signatures.

According to an embodiment, the first group of multiple users include the second group of multiple users.

According to an embodiment, the first group of multiple users is an unrestricted group of multiple users.

According to an embodiment, step 530 involves facilitating the use of the requested distributed storing automatically to the requesting user.

According to an embodiment, step 530 includes selectively providing, to the second group of multiple users, is in accordance with a respective authorization.

According to an embodiment, the artificial intelligence models are limited to artificial intelligence models having a maturity above a maturity level of confidence for autonomous driving applications.

According to an embodiment, the artificial intelligence models include but are not limited to artificial intelligence models having a maturity above a maturity level of confidence for autonomous driving applications.

According to an embodiment, at least one of the artificial intelligence models is below a maturity level of confidence for autonomous driving applications.

According to an embodiment, the artificial intelligence models are of different maturity levels of confidence for autonomous driving applications.

According to an embodiment, the request for use includes a request to download, from an artificial intelligence models library, at least one of the requested artificial intelligence model or the requested data.

According to an embodiment, the request for use includes a request to upload, from an artificial intelligence models library, at least one of the requested artificial intelligence model or the requested data.

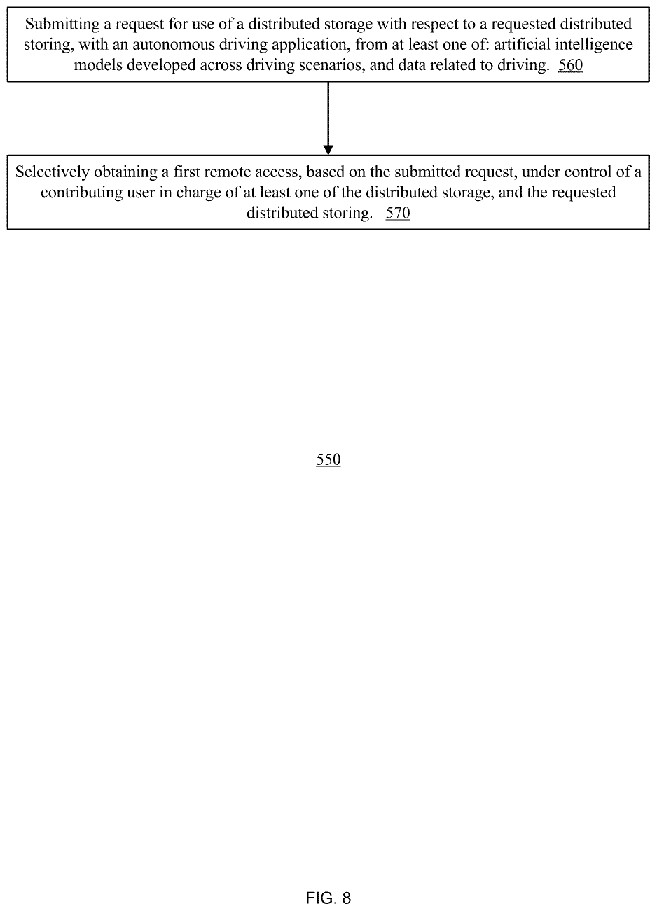

FIG. 8 illustrates an example of method 550 of distributed usage of AI based models for driving.

According to an embodiment, method 550 includes step 560 of submitting a request for use of a distributed storage with respect to a requested distributed storing, with an autonomous driving application, from at least one of: artificial intelligence models developed across driving scenarios, and data related to driving.

According to an embodiment, step 560 is followed by step 570 of selectively obtaining a first remote access, based on the submitted request, wherein the selectively obtaining involves at least one of: uploading, downloading, and accessing the requested distributed storing, such that the selectively obtained is facilitated under control of a user in charge of at least one of: the distributed storage, and the requested distributed storing.

According to an embodiment, the uploading involves adding a new artificial intelligence model to the distributed storage.

According to an embodiment, the uploading involves updating an existing artificial intelligence model of the distributed storage.

According to an embodiment, the uploading involves adding new driving-related data in association with an existing artificial intelligence model of the distributed storage.

According to an embodiment, the first remote access is for downloading content supplied by a contributing user.

According to an embodiment, the user is the contributing user.

According to an embodiment, the user differs from the contributing user.

According to an embodiment, step 560 is preceded by:
step 552 of receiving, from the contributing user and prior of the submitting of the request, a contribution request to provide the content that include one of adding a new model metadata related to a new model or to update an existing model metadata related to an existing model.
Step 554 of facilitating a controlled access to the distributed storage by the contributing user for conditionally adding the content, while preventing any other user of the first group of users that lacks an authorization to add the content to add the content.

According to an embodiment, the data related to the driving is data for use in a development of an artificial intelligence model.

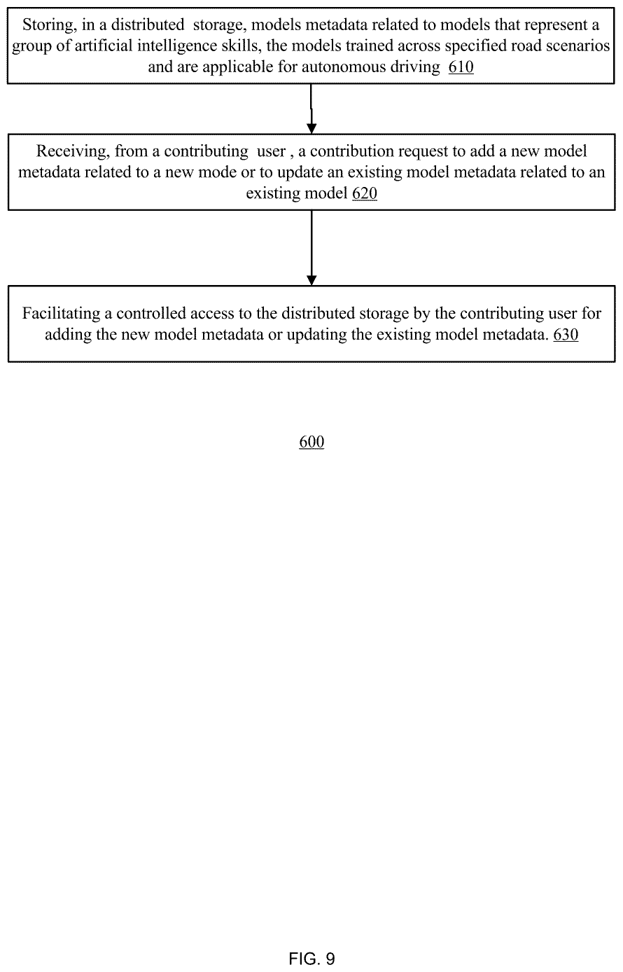

FIG. 9 illustrates an example of method 600.

According to an embodiment, method 600 includes step 610 of storing, in a distributed storage, models metadata related to models that represent a group of artificial intelligence skills, the models trained across specified road scenarios and are applicable for autonomous driving.

According to an embodiment, step 610 is followed by step 620 of receiving, from a contributing user, a contribution request to add a new model metadata related to a new mode or to update an existing model metadata related to an existing model.

According to an embodiment, step 620 is followed by step 630 of facilitating a controlled access to the distributed storage by the contributing user for conditionally adding the new model metadata or updating the existing model metadata, while preventing any other user of the first group of users that lacks an authorization to add the new model metadata from using the new model.

According to an embodiment the facilitating include sending a password or a key for establishing a secure communication session, updating permission metadata with the allowed access of the contributing user, and the like.

According to an embodiment, step 630 is executed automatically and in real time, and includes transmitting a request to access notification to the contributing user.

Because some aspects of the illustrated embodiments of the present disclosure may, for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any combination of any steps of any method illustrated in the specification and/or drawings may be provided. Any combination of any subject matter of any of claims may be provided. Any combinations of systems, units, components, processors, sensors, illustrated in the specification and/or drawings may be provided. Any combination of any module or unit listed in any of the figures, any part of the specification and/or any claims may be provided.

Any reference in the specification to a method should be applied mutatis mutandis to a device or system capable of executing the method and/or to a non-transitory computer readable medium that stores instructions for executing the method. Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

In the foregoing specification, the invention has been described with reference to specific examples of embodiments of the invention. It will, however, be evident that various modifications and changes may be made therein without departing from the broader spirit and scope of the invention as set forth in the appended claims. The specifications and drawings are, accordingly, to be regarded in an illustrative rather than in a restrictive sense.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Thus, the scope of the embodiments of the disclosure is defined by the appended claims and equivalents thereof. While certain features of the disclosure have been illustrated and described herein, many modifications, substitutions, changes, and equivalents will now occur to those of ordinary skill in the art. It is therefore to be understood that the appended claims are intended to cover all such modifications and changes as fall within the true spirit of the invention.

We claim

1. A method of distributed usage of AI based models for driving, comprising:
submitting a request for use of a distributed storage with respect to a requested distributed storing, with an autonomous driving application, from at least one of: artificial intelligence models developed across driving scenarios, and data related to driving; and
selectively obtaining a first remote access, based on the submitted request, wherein the selectively obtaining involves at least one of: uploading, downloading, and accessing the requested distributed storing, such that the selectively obtained is facilitated under control of a user in charge of at least one of: the distributed storage, and the requested distributed storing.

2. The method according to claim 1 wherein the uploading involves adding a new artificial intelligence model to the distributed storage.

3. The method according to claim 1, wherein the uploading involves updating an existing artificial intelligence model of the distributed storage.

4. The method according to claim 1, wherein the uploading involves adding new driving-related data in association with an existing artificial intelligence model of the distributed storage.

5. The method according to claim 1, wherein the first remote access is for downloading content supplied by a contributing user.

6. The method according to claim 5, wherein the user is the contributing user.

7. The method according to claim 5, wherein the user differs from the contributing user.

8. The method according to claim 5, wherein the method further comprises receiving, from the contributing user and prior of the submitting of the request, a contribution request to provide the content that include one of adding a new model metadata related to a new model or to update an existing model metadata related to an existing model.

9. The method according to claim 8, wherein the method further comprises facilitating a controlled access to the distributed storage by the contributing user for conditionally adding the content, while preventing any other user of the first group of users that lacks an authorization to add the content to add the content.

10. The method according to claim 1, wherein the data related to the driving is data for use in a development of an artificial intelligence model.

11. A system of distributed usage of AI based models for driving, the system comprising at least one processing device configured to:
submit a request for use of a distributed storage with respect to a requested distributed storing, with an autonomous driving application, from at least one of: artificial intelligence models developed across driving scenarios, and data related to driving; and
selectively obtain a first remote access, based on the submitted request, wherein the first remote access involves at least one of: upload, download, and access the requested distributed storing, such that the first remote access is facilitated under control of a user in charge of at least one of: the distributed storage, and the requested distributed storing.

12. A non-transitory computer readable medium storing instructions that, when executable by at least one processing device, cause the device to:
submit a request for use of a distributed storage with respect to a requested distributed storing, with an autonomous driving application, from at least one of: artificial intelligence models developed across driving scenarios, and data related to driving; and
selectively obtain a first remote access, based on the submitted request, wherein the first remote access involves at least one of: upload, download, and access the requested distributed storing, such that the first remote access is facilitated under control of a user in charge of at least one of: the distributed storage, and the requested distributed storing.
